(19) United States
(12) Patent Application Publication
(10) Pub. No.: US 2025/0120449 A1
(43) Pub. Date: Apr. 17, 2025

(54) AEROSOL PROVISION SYSTEM

(71) Applicant: NICOVENTURES TRADING LIMITED, London (GB)

(72) Inventors: Robert KERSEY, Brighton (GB); Nicholas ROSSER, London (GB); Darryl BAKER, London (GB); Connor BRUTON, London (GB); Mark CROSIER, Ipswich (GB)

(21) Appl. No.: 18/730,371

(22) PCT Filed: Jan. 19, 2023
(86) PCT No.: PCT/GB2023/050102

§ 371 Date: Jul. 19, 2024

(30) Foreign Application Priority Data
Jan. 21, 2022 (GB) 2200776.9

(51) Int. Cl. A24F 40/53; A24F 40/60

(52) U.S. Cl. CPC A24F 40/53; A24F 40/60

(57) ABSTRACT

There is provided an aerosol provision system (100, 200, 300) comprising: an aerosol provision device (110, 210, 310); and a consumable (120, 220, 320) comprising aerosol generating material, wherein the aerosol provision device comprises a plurality of operating states selectable by a user and wherein, upon identifying the consumable, the aerosol provision device is configured to allow a sub-set of the operating states corresponding to permitted operating states for the identified consumable, to be selectable by a user.

### TECHNICAL FIELD

The present invention relates to an aerosol provision system, an aerosol provision device, a method of providing an aerosol from an aerosol provision system, and aerosol provision means.

### BACKGROUND

Aerosol provision systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems. This may avoid the activation of the system in undesirable circumstances.

The present invention is directed toward solving some of the above problems.

### SUMMARY

Aspects of the invention are defined in the accompanying claims.

In accordance with some embodiments described herein, there is provided aerosol provision system comprising: an aerosol provision device; and, a consumable comprising aerosol generating material, wherein the aerosol provision device comprises a plurality of operating states selectable by a user and wherein, upon identifying the consumable, the aerosol provision device is configured to allow a sub-set of the operating states corresponding to permitted operating states for the identified consumable, to be selectable by a user.

Such a system is able to identify a consumable for use with the aerosol provision device and allow a sub-set of the full range of operating states for use with that consumable. In particular, in the event that consumable 1 is supplied for use with the aerosol provision device, sub-set 1 is proposed to the user for use with consumable 1. In contrast, when consumable 2 is supplied for use with the aerosol provision device, sub-set 2 is proposed for use with consumable 2. In this way, the manufacturer can provide a device that has a broad utility across a number of consumables, while protecting the device from being used with consumable/operating state combinations that might be dangerous or lead to an undesirable product being provided to the user.

The user experience of the device is also increased by having a personalisable, “plug-and-play” approach. In that, the user is provided with a number of options from which to select the operating state that the user desires. In this way, the user need not create, from scratch, an operating state for use with a consumable, but can refine their preference from a number provided. In this way, the safety of the device is also maintained as each of the possible selectable operating states are known by the manufacturer to provide a suitable aerosol without damaging the device. Therefore, both the device and user benefit from the arrangement.

The system may also prevent or limit use of the device with non-authentic consumables. In that, without identification of the consumable as might be the case with non-authentic consumables, the aerosol provision device may not be able to provide a suitable array of operating states. In this way, the device can be protected from use with unknown and un-tested consumables that might provide a substandard aerosol for the user or damage the device in an attempt to produce an aerosol.

In accordance with some embodiments described herein, there is provided an aerosol provision device comprising: a plurality of operating states selectable by a user for use with a consumable, wherein, upon identifying a consumable, the aerosol provision device is configured to allow a sub-set of the plurality of operating states corresponding to permitted operating states for the identified consumable, to be selectable by a user.

In accordance with some embodiments described herein, there is provided a method of providing an aerosol from an aerosol provision system, the method comprising: providing an aerosol provision device comprising a plurality of operating states selectable by a user; providing a consumable comprising aerosol generating material; identifying, by the aerosol provision device, the consumable; providing a sub-set of the operating states for selection by the user; and, upon receiving a selection for a specific operating state within the sub-set of operating states, activating the specific operating state.

In accordance with some embodiments described herein, there is provided aerosol provision means comprising: an aerosol provision device; and, a consumable comprising aerosol generating means, wherein the aerosol provision device comprises a plurality of operating states selectable by a user and wherein, upon identifying the consumable, the aerosol provision device is configured to allow a sub-set of the operating states corresponding to permitted operating states for the identified consumable, to be selectable by a user.

### DESCRIPTION OF DRAWINGS

The present teachings will now be described by way of example only with reference to the following figures:

FIG. 1 is a schematic view of an aerosol provision system according to an example;

FIG. 2 is a schematic view of an aerosol provision system according to an example;

FIG. 3 is a schematic view of an aerosol provision system according to an example; and,

FIG. 4 is a flow diagram according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

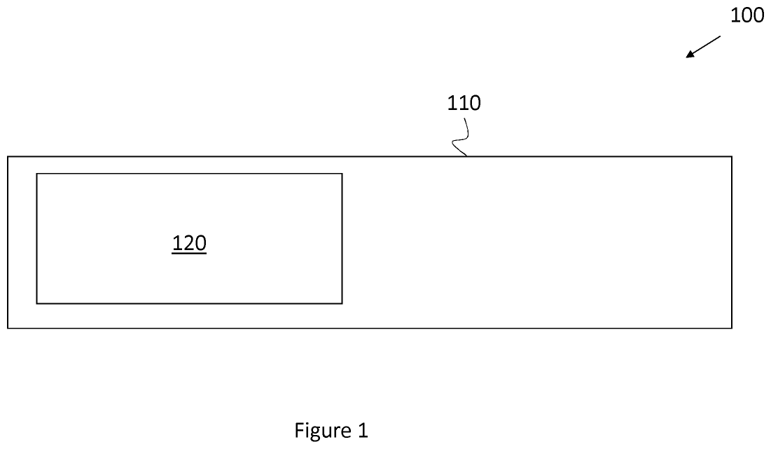

FIG. 1 illustrates a schematic view of an example of an aerosol provision system 100 according to the present invention. The aerosol provision system 100 has an aerosol provision device 110. The aerosol provision system 100 has a consumable 120. The consumable 120 comprises aerosol generating material. The aerosol provision device 110 comprises a plurality of operating states selectable by a user. Upon identifying the consumable 120 the aerosol provision device 110 is configured to allow a sub-set of the operating states corresponding to permitted operating states for the identified consumable 120 to be selectable by a user. In use, therefore, the user provides the consumable 120 to the aerosol provision device 110. The aerosol provision device 110 identifies the consumable 120. The aerosol provision device 110 then offers a selection from the full range of operating states to the user, for use with the consumable 120. The user may then select one such operating state for use with the consumable 120.

The full range of operating states of the aerosol provision device 110 may be very wide ranging such that the aerosol provision device 110 can be used with a correspondingly wide range of consumables 120. In this way, the user need not be limited to only certain types of consumable 120 for use with the aerosol provision device 110. However, from within this wide range, some operating states will not be suitable for use with some consumables 120. As such, it is important to offer states that will provide a desirable aerosol from the consumable 120. By offering all the possible states to all consumables, the onus would be put onto the user to work out which operating states interact well with which consumables 120. This would decrease the user experience of the system 100.

In an example, the sub-set of the plurality of operating states offered to the user comprises at least two operating states from the plurality of operating states. This advantageously provides the user with some option for receiving a personalised aerosol. As such, the user's experience of the device is improved by the provision of a choice of operating states. The two operating states may be one that provides a lower aerosol and one that provides a higher aerosol amount. In this way, while the heating profiles of the two operating states may not differ vastly, by being provided with two similar states, the device 110 may be protected and the user can still select their preference from two operating states.

In an example, the sub-set of the plurality of operating states comprises at least one “boost” operating state. The boost operating state is arranged to provide an increased aerosol from the aerosol provision system. In the “boost” operating state, the aerosol provision device 110 may provide more aerosol per puff for the user. As such, while the heating profile of the “boost” and “non-boost” operating states may be somewhat similar, the boost operating states provide a greater amount of aerosol to the user. The boost operating states may provide more energy to the heating element of the aerosol provision device 110 in comparison to the corresponding non-boost operating states. Such an operating state may be desirable for a user in certain circumstances. The flexibility of being provided with the option of such an operating state further improves the user experience of the aerosol provision device 110.

As such, in use, after providing a first specific consumable to the aerosol provision device 110 the user may be offered a first sub-set of operating states. Upon providing a second specific consumable to the aerosol provision device 110 the user may be offered a second sub-set of operating states. These two sub-sets may have no operating states in common, some operating states in common, or all operating states in common. The similarity of the properties of the consumables will impact the number of operating states in common. For example, if the consumables have very different properties, there two sub-sets may be entirely different. One specific consumable may be used with a large range of operating states, as such the sub-set offered will contain a large number of operating states, whereas other consumables may be used with only a small range of operating states. In an example, upon identification, a consumable may only have one operating state provided in the sub-set of operating states.

The property of the consumable that may impact the number of operating states offered may be any of a chemical composition of the aerosol generating material, a strength of the aerosol generating material, a size of the consumable, a rating of the consumable, an authenticity of the consumable or the like.

The “rating” of the consumable 120 may relate to whether the consumable 120 is from a batch that has a particularly high concentration of one compound, has multiple aerosol generating materials within the consumable 120, or any other relevant factor. Such properties inform the aerosol provision device 110 on identification of the consumable 120 and result in the population of the sub-set of operating states offered to the user for use with that consumable 120.

In an example, the consumable 120 is identified as containing fairly standard aerosol generating material. The aerosol provision device 110 identifies this and offers a suitable sub-set of operating states for use. For a standard aerosol generating material, there may be a wider sub-set of operating states offered than for consumables with less common aerosol generating material. This may be because the manufacturer has performed more tests on standard aerosol generating materials and therefore is aware that a wide sub-set of operating states can safely be offered. In contrast, the manufacturer may have less information on less common aerosol generating materials and therefore could opt to provide only those operating states known to be safe and provide a desirable aerosol.

In the example shown in FIG. 1, the consumable 120 is shown located inside the aerosol provision device 110 forming the aerosol provision system 100. In this example, the consumable 120 may be inserted into the housing of the aerosol provision device 110. In this way, when located inside the aerosol provision device 110, the aerosol provision device 110 may identify the consumable 120. The consumable 120 may be a pod or a cartridge containing an aerosol generating material which is inserted into the aerosol provision device 110 and then discarded or refilled after use.

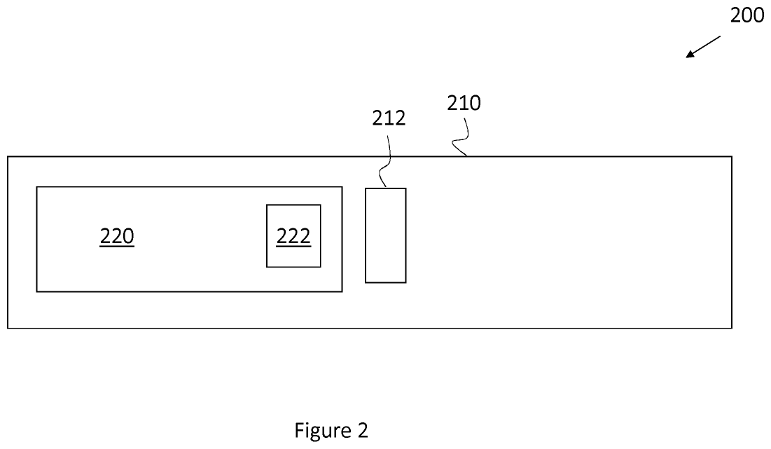

Referring now to FIG. 2, there is a shown a similar system 200 to the system 100 of FIG. 1. Similar features, to those features used in FIG. 1, are shown with the reference numerals increased by 100. For example, the system 100 of FIG. 1 is similar to the system 200 of FIG. 2. Similar or identical features may not be discussed for conciseness.

The system 200 of FIG. 2 has control circuitry 212 in the aerosol provision device 210. The consumable 220 has an identifier 222 for indicating a property of the consumable 220. The arrangement of system 200 is such that the control circuitry 212 of the aerosol provision device 210 identifies the property of the consumable 220 from the identifier 222.

The control circuitry 212 is arranged such that, when the consumable 220 is inserted into the aerosol provision device 210 prior to use, the control circuitry 212 is able to read the identifier 222. The identifier identifies the property of the consumable 220 such that, when read, the aerosol provision device 210 provides a suitable sub-set of operating states to the user for use with the consumable 220. As mentioned above, the property may relate to the consumable 220, may relate to the content of the aerosol generating material within the consumable 220. Based on the property, the sub-set of operating states are provided. This helps to confirm that the operating states that are provided are suitable for the consumable 220 in the aerosol provision device 210.

The identifier 222 may be a coded identifier which can be read by the control circuitry 212. The identifier 222 of the consumable 220 may be any of a QR code, a bar code, and, an RFID tag. The control circuitry 212 may correspond to the identifier 222 such that if the identifier 222 is a QR code, the control circuitry 212 is a QR code reader. The identifier 222 may be an RFID and the control circuitry 212 may be an RFID reader. Other identifier/detector pairs are possible.

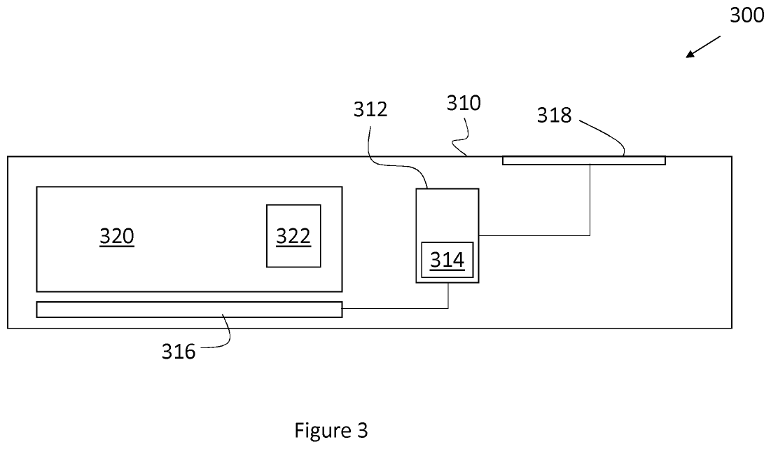

Referring now to FIG. 3, there is a shown a similar system 300 to the system 200 of FIG. 2. Similar features, to those features used in FIG. 2, are shown with the reference numerals increased by 100. For example, the system 200 of FIG. 2 is similar to the system 300 of FIG. 3. Similar or identical features may not be discussed for conciseness.

The aerosol provision device 310 of FIG. 3 has a memory 314 for storing a database of properties of consumables 320 and related operating states of aerosol provision devices. The memory 314 need not be part of the control circuitry 312 as shown in the example of FIG. 3. Rather the memory 314 in this specific example is on board the device 310 and part of the control circuitry 312. The system 300 also has a heater 316. The heater 316 may be a heating element, atomiser, heater, vibrating plate or the like suitable for forming an aerosol from a consumable 320. The heater 316 is connected to the control circuitry 312. The control circuitry 312 upon determining a property of the consumable 320, may send a signal to the heater 316 to either operate such that an aerosol is produced, or not operate so that an aerosol is not produced. This is discussed in more detail below. In this way, the control circuitry 312 may be configured to change a default state of the aerosol provision device 310 to a non-operating state upon, for example, not detecting a property and therefore not identifying a consumable. This may assist in preventing the device 310 being used with non-authentic consumables.

The system 300 of FIG. 3 also has a display 318. The display 318 is for displaying to a user the sub-set of operating states available for use with the identified consumable 320. The display 318 may be a touchscreen display, for displaying a visual signal to the user and receiving input from the user.

In use, the consumable 320 is inserted into the aerosol provision device 310. The control circuitry 312 identifies a property of the consumable 320 from the identifier 322. The control circuitry 312 checks the property against a database of properties of consumables and associated suitable operating states. The control circuitry 312 may check this in the on board memory 314. The control circuitry 312 then sends a signal to the display 318 to show the available operating states to the user. The user provides an indication of the desired operating state for use. The control circuitry 312 receives this signal and provides a corresponding instruction to the heater 316. In this way, the user is provided with a personalised but safe heating profile from having inserted the consumable 320 into the aerosol provision device 310.

The determination of the sub-set of operating states for use with the consumable 320 may occur on the aerosol provision device 310, or remotely, via communication with a database of properties and associated operating states. Such a database may for example take the form of, if property X identified, provide operating states A to C, if property Y identified, provide operating states D, E, etc. The database could be a look up table providing the aerosol provision device 310 with instructions as to which operating states are suitable for use with which properties. The property or properties contained in the identifier give a complete picture to the control circuitry 312 as to which operating states to provide.

In the above example, the control circuitry 312 detects the property and compares in the database in the memory 314. This memory is on board memory and the database is also on board. This may be advantageous as the system 300 need not have a communications element in the system 300 to communicate with a remotely held database, and the system 300 need not be connected to a communications network to access a remotely held database prior to each use session.

In a different example, the database of properties and associated operating states is held remotely, and the control circuitry 312 has a communications element to contact the database. The control circuitry 312 may contact the database with a request for suitable operating states for the identified consumable 320. The control circuitry 312 is then provided with an indication as to which operating states to offer to the user. This arrangement may be advantageous as the system 300 need not include a memory element for carrying the database and the database can be remotely updated ensuring the device 310 need not have the on board database regularly updated. In this way such that recently amended property/operating states pairings can be provided to all devices as soon as the amendments are uploaded to the central database. In this way, all users can be provided with the updates without each needing to update their own device 310.

During use, the user's preference for certain operating states with certain consumables 320 may be stored in the memory 314. In this way, if the user is offered operating states A to C for consumable X and the user repeatedly requests operating state A, the memory 314 may store this and ask the user if this is to be the automatic operating state for consumable X. In this way, the device 310 may be made to provide a bespoke performance for each user from within the safety provided by the sub-set of operating states being offered to the user.

In an “operating state”, elements of the aerosol provision device 310 used to generate an aerosol (such as an atomiser, heater or the like 316) may be activated. The specific activation of the device 310 may require an additional input which may be inhalation on the device 310, pressing a button on the device 310 or the like, alternatively the device 310 may automatically generate aerosol by the heater 316 upon receiving a signal, regarding selection of an operating state by the user from the control circuitry 312.

The term “operating state” refers to a state in which the system may be used to provide an aerosol. The system can provide a large number of “operating states”. Specific consumables 320 may provide a suitable aerosol for a user under a suitable heating profile (fast, slow, high temperature, low temperature, etc.) or via a suitable heating mechanism (heater element, atomiser, vibrating plate, etc.). As such specific, operating states may dictate the performance of the system 300, such as selecting the heating mechanisms used and the heating profile used based on the identified properties of the consumable 320. Such operating states may be associated with specific consumables or be used across an array of consumables. In this way, upon identification of property 1, corresponding heating mechanism 1 is offered to provide heating profile 1 on the consumable 1. Upon identification of property 2, corresponding heating mechanism 2 may be offered to provide heating profile 2 on consumable 2. In this way, different consumables can have a range of suitable predetermined aerosol offered to the user for provision, upon recognition of that consumable. This improves the ease of use of a device 310 for a user.

As identification is required to provide the sub-set of operating states, the system 300 works best with consumables with identifiers 322. As such, authentic consumables, i.e. those made by the manufacturer with identifiers, can be used properly in the system 300. The device 310 may prevented from operating with non-authentic consumables by having a default setting of not providing operating states for use with a consumable if the consumable cannot be identified. Alternatively, the device 310 may not prevented from operating with non-authentic consumables. Instead, the device 310 may have an inbuilt very conservative heating profile, that is specifically designed to be likely to produce a reasonable aerosol from most consumables. This may be the singular operating state offered in response to identification that a consumable is present in the device 310 but that an identifier has not been identified. The use of a very conservative heating profile is not likely to damage any components, or produce burnt flavours or the like and as such is advantageous to use in circumstances where the consumable 320 is unknown. In this way, non-authentic consumables can be used by the user but the user experience is diminished by opting to do so as there is no personalisation possible from the non-authentic consumable. In this way, a balance is struck between enabling the user to use any consumables, thereby offering the user greater choice, and encouraging the user to use authentic consumables for reasons of both security and performance.

Such a conservative heating profile as referred to above may be the default operating state of the device 310, and it can be activated by inhaling on the device 310 or pushing a button, once a consumable 320 is provided into the aerosol provision device 310.

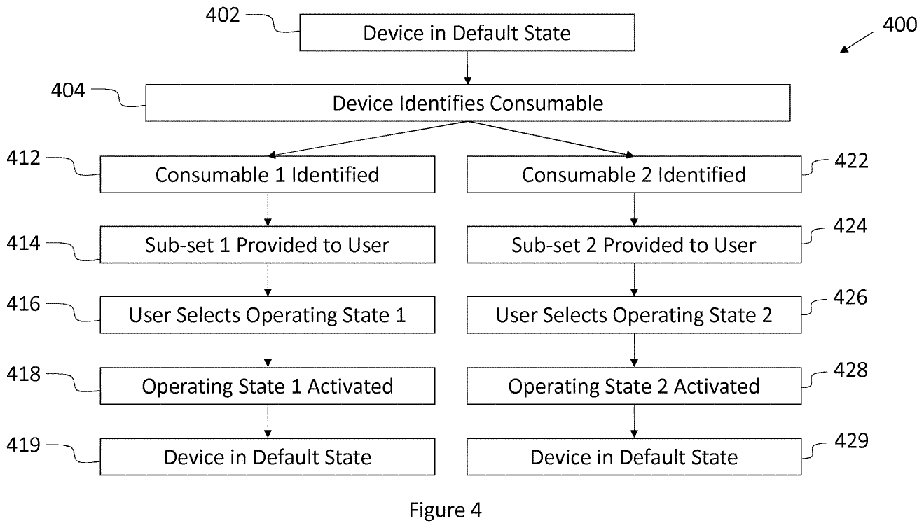

FIG. 4 shows a method 400 of use of an aerosol provision system. In the method 400, the device may start in a default state 402, which may be a non-operating state such that non-authentic consumables cannot be used with the device. Alternatively, the default operating state may be the conservative heating profile operating state as described above.

When a user inserts a consumable into the aerosol provision device, the device identifies the consumable 404. The device may identify the consumable as one type of consumable or another. In the specific example shown, the method branches on identification of consumable 1 (step 412) and identification of consumable 2 (step 422) to illustrate the system.

In step 412, the device identifies the consumable as known consumable 1. This may take the form of recognising the identifier by a control circuitry and identifying a property or properties of the consumable from the identifier.

In step 414, a sub-set 1 of operating states is provided to a user. This may take the form of cross checking the identified consumable and property against a database comprising suitable operating states for specific consumables. The database may be on board the device or held remotely and contacted for the operating states. In this instance, the sub-set of operating states is referred to as sub-set 1.

In step 416, the user selects the operating state that is desired for use on the consumable. In this example this is operating state 1. This may take the form of selecting, via a touch screen display or the like on the device from the options of operating states provided in the sub-set 1 of step 414.

In step 418, the operating state 1 is activated. This may take the form of a signal from the display being received by the control circuitry which is passed on to the heater or atomiser of the device. The user may activate the device as mentioned above by use of a push button or inhalation or the like. In any case, operating state 1 is used to provide an aerosol from consumable 1.

In step 419, once the smoking session is ended or concluded, the device may be returned to the default state of step 402.

If a different consumable is identified in step 404, the method may move to step 422, wherein the device identifies the consumable as known consumable 2. As above, this may take the form of recognising the identifier by a control circuitry and identifying a property or properties of the consumable from the identifier.

Accordingly, in step 424, a sub-set of operating states associated with consumable 2 are provided to the user for selection. This is sub-set 2. As mentioned above, there may be some operating states in common between sub-set 1 of step 414 and sub-set 2 of step 424. There may be no operating states in common. This will likely depend on the similarity of the properties of the two consumables.

In step 426, the user selects the operating state that is desired for use on the consumable. In this example this is operating state 2. This may take the form of selecting, via a touch screen display or the like on the device from the options of operating states provided in the sub-set 2 of step 424.

In step 428, the operating state 2 is activated. This may take the form of a signal from the display being received by the control circuitry which is passed on to the heater or atomiser of the device. The user may activate the device as mentioned above by use of a push button or inhalation or the like. In any case, operating state 2 is used to provide an aerosol from consumable 2.

In step 429, once the smoking session is ended or concluded, the device may be returned to the default state of step 402.

The sub-set of operating states provided for use with a specific consumable will be balanced against the properties of the consumable in testing by the manufacturer. In this way, the heating profiles offered are reasonable for use with the consumables. In an example, a consumable has a particularly high nicotine content and therefore a lesser heating profile can be applied to provide an aerosol with a reasonable nicotine content. Conversely, a consumable with a low content may have more significant heating profiles offered to provide an aerosol with a reasonable nicotine content.

In more complex arrangements, the consumable may contain more than one aerosol generating material and the device may have more than one heating element. The identifying process may then involve identifying the various aerosol generating materials and providing sub-sets of operating states for each of the aerosol generating materials within the consumable. The user may then be provided with an option of operating states for each aerosol generating material in the consumable. Again, such a service can be provided in this arrangement as the device is designed to provide a wide ranging options of heating profiles. As such, this can be used to benefit the user by providing one device that can provide an aerosol from a wide range of materials.

In the arrangements herein, the device recognising the consumable is the aerosol provision device. There may be arrangements wherein a remote device such as a smartphone or the like is used to recognise the consumable. This may then communicate the identity and property of the consumable to aerosol provision device. The sub-set of operating states may still be held in a database either on the remote device, on the aerosol provision device, or remotely, such as on a server. Therefore, the sub-set of states may be determined by the remote device or the aerosol provision device. In this instance, the aerosol provision device may receive the identification of the consumable or simply receive the sub-set of operating states to offer the user. The sub-set of operating states may also refer to the smartphone. In particular, rather than just being heating modes for the aerosol provision device, the operating states may refer to operating states of the smartphone and refer to features such as UI layout, lighting schemes, notification availability or the like. In particular, enabling a user to interact with their device via a smartphone using an authentic consumable, and preventing this function with a non-authentic consumable may significantly improve the user experience and therefore encourage the user to use authentic consumables.

In a particular example, the device disclosed herein may operate with a flavour pod which is replaceable in the device. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision system comprising: an aerosol provision device; and, a consumable comprising aerosol generating material, wherein the aerosol provision device comprises a plurality of operating states selectable by a user and wherein, upon identifying the consumable, the aerosol provision device is configured to allow a sub-set of the operating states corresponding to permitted operating states for the identified consumable, to be selectable by a user.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision system comprising:
an aerosol provision device; and,
a consumable comprising aerosol generating material,
wherein the aerosol provision device comprises a plurality of operating states selectable by a user and wherein, upon identifying the consumable, the aerosol provision device is configured to allow a sub-set of the operating states corresponding to permitted operating states for the identified consumable, to be selectable by a user.

2. An aerosol provision system according to claim 1, wherein the sub-set of the plurality of operating states comprises at least two operating states from the plurality of operating states.

3. An aerosol provision system according to claim 1, wherein the sub-set of the plurality of operating states comprises at least one boost operating state, wherein the boost operating state is arranged to provide an increased aerosol from the aerosol provision system.

4. An aerosol provision system according to claim 1, wherein the aerosol provision device further comprises control circuitry and wherein the consumable comprises an identifier for indicating a property of the consumable, configured such that the control circuitry of the aerosol provision device identifies the property of the consumable from the identifier.

5. An aerosol provision system according to claim 4, wherein the identifier of the consumable is at least one of: a QR code; a bar code; and, an RFID tag.

6. An aerosol provision system according to claim 4, wherein the property of the consumable is at least one of:
a chemical composition of the aerosol generating material,
a strength of the aerosol generating material,
a size of the consumable,
a rating of the consumable.

7. An aerosol provision system according to claim 4, wherein the control circuitry is configured to provide the sub-set of operating states to a user based on identification of the property of the consumable.

8. An aerosol provision system according to claim 1, wherein the aerosol provision device is configured to be in a non-operating state upon not identifying the consumable.

9. An aerosol provision system according to claim 1, further comprising a memory for storing a database of properties of consumables and related operating states of aerosol provision devices.

10. An aerosol provision system according to claim 1, further comprising a display for displaying, to the user, the sub-set of operating states for the identified consumable,
the display arranged to receive an input from the user as to the desired operating state for use from the sub-set of operating states.

11. An aerosol provision device comprising:
a plurality of operating states selectable by a user for use with a consumable,
wherein, upon identifying a consumable, the aerosol provision device is configured to allow a sub-set of the plurality of operating states corresponding to permitted operating states for the identified consumable, to be selectable by a user.

12. An aerosol provision device according to claim 11, wherein the sub-set of the plurality of operating states comprises at least two operating states from the plurality of operating states.

13. An aerosol provision device according to claim 11, further comprising a memory for storing a database of properties of consumables and related operating states of aerosol provision devices.

14. A method of providing an aerosol from an aerosol provision system, the method comprising:
providing an aerosol provision device comprising a plurality of operating states selectable by a user;
providing a consumable comprising aerosol generating material;
identifying, by the aerosol provision device, the consumable;
providing a sub-set of the operating states for selection by the user; and,
upon receiving a selection for a specific operating state within the sub-set of operating states, activating the specific operating state.

15. Aerosol provision means comprising:
an aerosol provision device; and,
a consumable comprising aerosol generating means,
wherein the aerosol provision device comprises a plurality of operating states selectable by a user and wherein, upon identifying the consumable, the aerosol provision device is configured to allow a sub-set of the operating states corresponding to permitted operating states for the identified consumable, to be selectable by a user.
